(19) United States
(12) Patent Application Publication
(10) Pub. No.: US 2008/0247184 A1
(43) Pub. Date: Oct. 9, 2008

(54) KEYLESS ENTRY SYSTEM

(76) Inventors: Yoshiyuki Matsumoto, Tokyo (JP); Hiroshi Uematsu, Tokyo (JP); Takuya Kushimoto, Tokyo (JP); Yutaka Ishiyama, Tokyo (JP)

Correspondence Address: CERMAK KENEALY & VAIDYA, LLP, 515 EAST BRADDOCK RD SUITE B, Alexandria, VA, 22314, US

(21) Appl. No.: 12/055,625

(22) Filed: Mar. 26, 2008

(30) Foreign Application Priority Data
Mar. 30, 2007 (JP) 2007-091245

(51) Int. Cl. B60Q 1/00; G08B 29/00

(52) U.S. Cl. 362/487; 340/5.61

(57) ABSTRACT

A conventional keyless entry system uses a radio wave as an unlocking or locking signal and is therefore substantially non-directional. For example, when an unlocking operation is performed, keys of all doors are unlocked, so that for example in a vehicle having a certain slide door or a kick-up door, an occupant of the vehicle may forget to lock the door. According to the presently disclosed subject matter a keyless entry system for locking and unlocking lock(s) of a vehicle can include an infrared light projector having a narrow radiation angle, and a light receiving/emitting unit corresponding to operating conditions of keys/locks. The light receiving/emitting unit can include a combination of a light receiving element for receiving the infrared light and a light emitting element for indicating the position of a key/lock which is operated correspondingly to the infrared light received by the light receiving element. Thus, among other features, locking and unlocking of only a requested door by means of the narrow radiation angle can be accomplished.

This application claims the priority benefit under 35 U.S.C. §119 of Japanese Patent Application No. 2007-091245 filed on Mar. 30, 2007, which is hereby incorporated in its entirety by reference.

### BACKGROUND

1. Field

The presently disclosed subject matter relates to a keyless entry system having a construction in which a vehicle door can be unlocked by pushing, for example, a button of a device like a TV remote controller when the operator (e.g., driver of the vehicle concerned) approaches the vehicle at a suitable distance. The unlocking operation can be accomplished without inserting a key into a keyhole of the vehicle door to effect unlocking. More particularly, the disclosed subject matter is concerned with a keyless entry system of the type which uses infrared light for communication with a vehicle with respect to opening or closing of doors, for example.

2. Description of the Related Art

Japanese Patent Laid-Open Publication No. 2006-144432 discloses a conventional keyless entry system. FIG. 9 of the present application shows a constructional example of a conventional keyless entry system 90 of this type. An operator of the vehicle has an electronic key 91 which is a radio wave transmitter. A radio wave coded for each vehicle is emitted by pushing a button of the electronic key 91.

The vehicle 80 includes a processor 81 and a buzzer driver 82. First, the radio wave transmitted from the electronic key 91 is analyzed to check whether the radio wave orders unlocking (or locking) for this vehicle. In the case of an unlocking (or locking) order, unlocking (or locking) is performed by the processor 81.

At the same time the processor 81 turns ON the buzzer driver 82. First, an ambient noise is measured by a microphone 83 and a buzzer 84 is allowed to sound at an appropriate sound volume on the basis of the sound volume of the ambient noise, announcing to the driver and other persons and/or entities that unlocking (or locking) of this vehicle was performed. However, in the above described conventional keyless entry system 90, first, since a radio wave is used for both locking and unlocking, the transmitter that is used is of about the size of a key holder at most and cannot emit many kinds of coded radio waves. Such a transmitter usually emits, for example, one kind of a coded radio wave.

Therefore, for example when the driver exits the vehicle, all four doors of the vehicle are unlocked if the vehicle is a four-door vehicle. As the case may be, a door is apt to be left unlocked when parking, thus giving rise to the problem that the vehicle is more likely to suffer from damage due to theft, vandalism, etc.

When locking or unlocking is performed, the buzzer 84 is sounded to inform the operator that the said operation was performed. Generally, however, ambient noise differs greatly between daytime and nighttime operation. Therefore, to prevent the buzzer from sounding at an excessively large volume, an ambient noise is measured by the microphone 83 and the buzzer is sounded at an appropriate sound volume on the basis of the measurement result, as noted above. However, there are certain problems associated with sound characteristics. For example, there exists a problem of variable sound volume and a problem of variable sound quality. No matter how low the sound volume and how good the sound quality may be, there inevitably exist people who do not prefer the particular sound characteristics. This point has also been regarded as a problem.

### SUMMARY OF THE DISCLOSED SUBJECT MATTER

According to the present disclosed subject matter, the above-mentioned and other characteristics, problems, and features of the conventional art are taken into consideration when providing a keyless entry system for locking and unlocking at least a certain lock of a vehicle. The keyless entry system can include an infrared light projector having a narrow radiation angle and a light receiving/emitting unit corresponding to operating conditions of certain locks or keys. The light receiving/emitting unit can include at least one set of structures that have a combination of a light receiving element for receiving the infrared light and a light emitting element for indicating the position of a lock which has come into operation correspondingly to the infrared light received by the light receiving element. With this keyless entry system, all of the doors can be prevented from being inappropriately unlocked or locked at the same time. In addition, a sound for confirming the operation that is or has been performed is not generated. Thus, the foregoing described conventional problems can be solved or prevented.

Because infrared light is used for the unlocking command, lapping and transmission as occurs in the conventional use of radio wave energies/frequencies can be avoided. In addition, only a door that is requested to be unlocked by a vehicle occupant, e.g., only the driver's seat-side door can be specifically unlocked. Consequently, certain problems associated with the conventional keyless entry system, which may lead leaving a door unlocked due to all the doors being unlocked at the same time, can be prevented.

Moreover, since locking and unlocking are announced by using a light, a sound is not generated even during parking at night. For example, even when going home late at night, it is possible to prevent disturbing the neighbors due to a sound emitted from the keyless entry system.

### BRIEF DESCRIPTION OF THE DRAWINGS

FIG. 1 is a perspective view showing an embodiment of a keyless entry system made in accordance with principles of the presently disclosed subject matter;

FIG. 2 is a perspective view showing a unit section of the keyless entry system of FIG. 1;

FIG. 3 is an explanatory diagram showing the construction of the keyless entry system of FIG. 1;

FIG. 4 is a sectional view taken along line A-A in FIG. 2;

FIG. 5 is a plan view showing another embodiment of a keyless entry system made in accordance with principles of the presently disclosed subject matter;

FIG. 6 is an explanatory diagram showing an example in which a keyless entry system made in accordance with principles of the presently disclosed subject matter is attached to a vehicle;

FIG. 7 is an explanatory diagram showing another example of installation;

FIG. 8 is an explanatory diagram showing a further example of installation; and

FIG. 9 is a block diagram showing a conventional example of a keyless entry system.

### DETAILED DESCRIPTION OF EXEMPLARY EMBODIMENTS

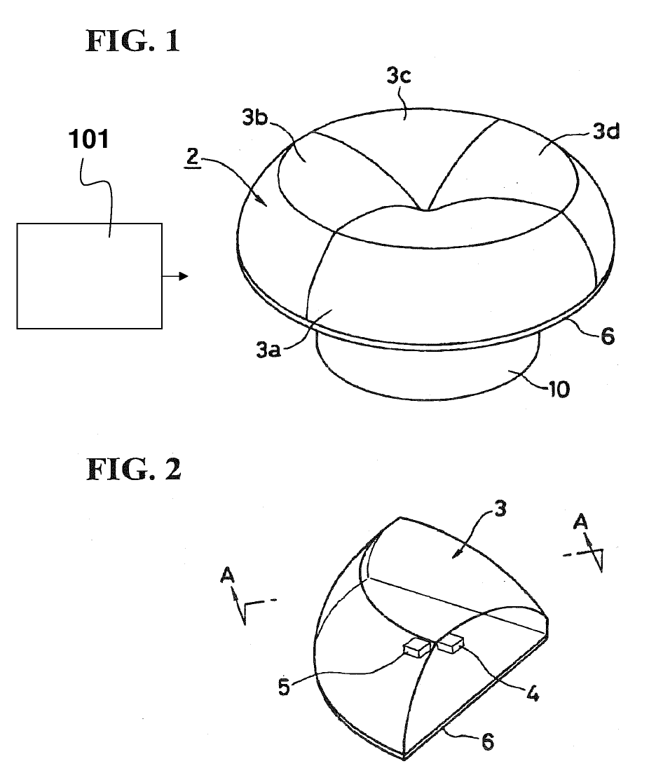

The presently disclosed subject matter will now be described in detail by way of embodiments thereof illustrated in the drawings. FIG. 1 shows a light receiving/emitting unit 2 that is a component of a keyless entry system 1. In this embodiment, the light receiving/emitting unit 2 is made up of four unit sections 3 which are gathered into a disc shape and correspond to a four-door vehicle for example.

The light receiving/emitting unit 2 is usually attached to an outer ceiling/roof of the vehicle in a state in which the four unit sections 3 (a-d in the case of a four-door vehicle) face upward and a processing circuit 10 is embedded for example within the vehicle ceiling.

Each unit section 3 (a-d, these symbols will hereinafter be omitted except when required for explanation) can be formed of a light transmitting material and, as shown in FIG. 2, a light receiving element 4 and a light emitting element 5 can be mounted in the interior of each unit section 3. Indicated at 6 in the figure is a circuit board. For example, wiring for conducting the infrared light (or signal related thereto) received by the light receiving element 4 to the processing circuit 10 and printed wiring for lighting the light emitting element 5 can be formed on the circuit board 6. Though not shown, pads for mounting the light receiving element 4 and the light emitting element 5 can also be provided so that both elements 4 and 5 can be mounted at respective predetermined positions.

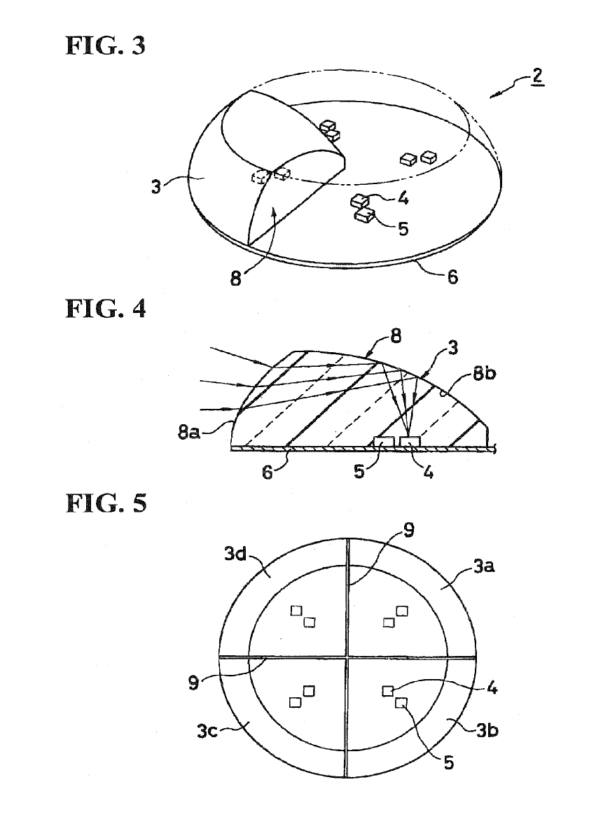

FIG. 3 is an explanatory diagram showing one unit section 3 in a mounted state on the circuit board 6. In an assembling step, first, the light receiving element 4 and the light emitting element 5 are die-mounted at respective predetermined positions of the circuit board 6. Then, the light receiving element 4 and the light emitting element 5 can be wired to the circuit board 6 by wire bonding with use of, for example, gold wire or aluminum wire. Thereafter, where required, the light receiving element 4 and the light emitting element 5 are covered for protection with soft resin, e.g., gel-like resin, and are then covered with, for example, epoxy resin to form a resin case 8, which is then cured to form one unit section 3.

FIG. 4 shows a section of the unit section 3 formed in the above manner. The unit section 3 is attached, for example, to a vehicle ceiling or roof portion in the illustrated state in which the resin case 8 assumes an upper position. In this case, the resin case 8 can include a light receiving portion 8a having a generally convex lens-like projected surface for receiving light emitted from an infrared light projector 101 which is operated from the exterior of the vehicle by a user (e.g., vehicle occupant). A reflecting portion 8b can be provided which also has a generally convex lens shape which extends somewhat forwardly upward.

When infrared light is radiated by a user/vehicle occupant to the light receiving portion 8a of the resin case 8, the infrared light is efficiently introduced into the light receiving portion 8a which can be formed of a material higher in refractive index than the atmosphere. In this case, since the light receiving portion 8a is formed in a convex lens shape having an appropriate curvature, the light is converged and travels through the interior of the resin case 8 and reaches the reflecting surface 8b. The infrared light is reflected by the reflecting surface 8b and changes its traveling course to the downward direction, i.e., toward the circuit board 6, in the illustrated state.

Since the light receiving element 4 is mounted on the circuit board 6, the infrared light introduced from the light receiving portion 8a of the resin case 8 eventually reaches the light receiving element 4, which then comes into operation. As a result, unlocking (or locking) is performed by the processing circuit 10 and, at the same time, the light emitting element 5 mounted in the same unit section 3 can be lit to inform a user/vehicle occupant that the requested door was unlocked.

Although the above description was in reference to the operation of one unit section 3 in a four door device, there are other types of vehicles that have a different number of doors, e.g., 2- or 5-door vehicle, etc. The number of unit sections 3 can correspond to the number of doors in a given vehicle. In addition, there are users who may want to unlock the engine hood (or front lid) and the rear lid (or trunk lid) with use of a keyless entry system. Therefore, the number of the unit section 3 that can be provided can be changed to account for such desires.

However, as the number of the unit sections 3 increases, it may become difficult to radiate infrared light accurately to only one unit section 3 which performs a requested function. Moreover, the leakage of light between the unit sections 3 may increase which may result in a malfunction such as two locks/keys operating simultaneously. To avoid such an inconvenience, as shown in FIG. 5, a partition wall 9 of an opaque or substantially opaque material can be provided between each of the adjacent unit sections 3 to diminish the leakage of light between the unit sections.

According to the above description the light emitting element 5 lights up when a door lock or the like is locked or unlocked. However, a study of actual vehicular working conditions shows that while a lock is usually locked during parking or stopping in a parking lot or the like, that locking is also sometimes done when the vehicle is running. Therefore, a change may be made such that the light emitting element 5 lights up during unlocking and goes out during locking.

According to the presently disclosed subject matter, as described above, each door can be independently opened and closed in principle, whereby it is possible to avoid the occurrence of all the doors being unlocked even when only the driver gets in the vehicle. The problem in which a vehicle is operated or is left running with all (or some) of the doors left unlocked without the driver becoming aware of this condition can be prevented.

In addition, since the announcement of locking and unlocking is made by turning ON and/or OFF of light, it is possible to reduce nuisance to neighbors even late at night and the influence of ambient conditions such as ambient brightness can be diminished because the lighting environment of the light emitting element can be the interior of the vehicle. Besides, by adopting a light emitting element 5 having a specific color, it is possible to make positive distinction from natural light and hence possible to confirm locking and unlocking in a positive manner.

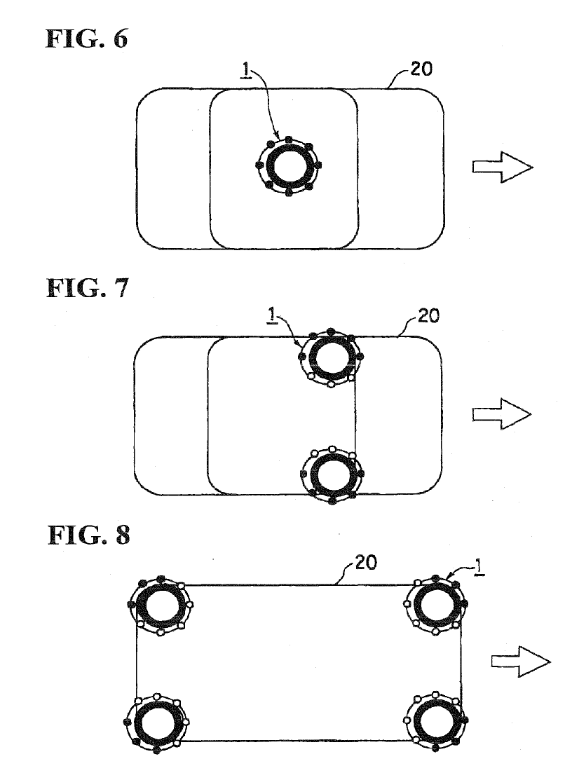

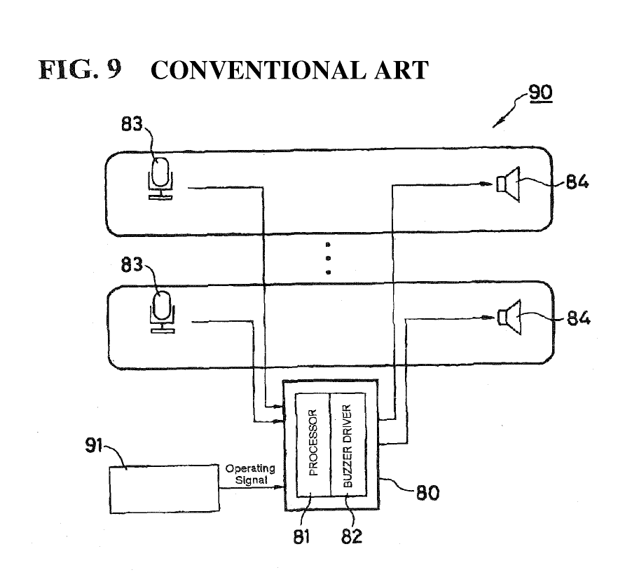

FIGS. 6 to 8 show examples of mounting positions of the keyless entry system 1 according to examples of the presently disclosed subject matter when attached to an vehicle 20. FIG. 6 shows an example of mounting in which the keyless entry system 1 is attached to a nearly central position of the ceiling of the vehicle 20. This way of mounting is suitable for a vehicle having four doors (e.g., a sedan).

FIG. 7 shows an example of mounting of the keyless entry system 1 suitable for an vehicle having a driver's seat on the road shoulder side and on which the driver often gets out from the road shoulder side.

Further, FIG. 8 shows an example of mounting in which elements of the keyless entry system 1 are mounted at each of four corners of a vehicle. This way of mounting is suitable for a vehicle having window glass positions that are high and close to front and rear ends of the vehicle and when installation of the keyless entry system 1 in a central portion of the vehicle ceiling may give rise to aesthetic or design problems or in which rear doors are opened and closed frequently. According to the mounting methods shown in FIGS. 7 and 8, there are overlapping portions in sensitivity direction of the light receiving elements 4. Therefore, as indicated by white circles in the figures, the light emitting elements 4 on one side may be omitted with respect to the overlapping portions.

While there has been described what are at present considered to be exemplary embodiments of the invention, it will be understood that various modifications may be made thereto, and it is intended that the appended claims cover such modifications as fall within the true spirit and scope of the invention. All conventional art references described above are herein incorporated in their entirety by reference.

What is claimed is:

1. A keyless entry system for locking and unlocking at least a certain lock of a vehicle, comprising:
an infrared light projector configured to project infrared light having a narrow radiation angle; and
a light receiving/emitting unit which operates corresponding to operating conditions of respective locks, said light receiving/emitting unit including at least one unit section, said unit section having a light receiving element configured to receive the infrared light and a light emitting element configured to emit light corresponding to and indicating the position of a respective lock which is operated in correspondence with the infrared light received by the light receiving element.

2. The keyless entry system according to claim 1, wherein said light receiving/emitting unit is divided into a plurality of unit sections each having a combination of light receiving element and light emitting element configured to indicate a position of a respective lock which is operated in correspondence with a signal output by the light receiving element, the plurality of unit sections being combined and united.

3. The keyless entry system according to claim 1, wherein one unit section of said light receiving/emitting unit is formed of a light transmitting material in a shape such that when combined as the light receiving/emitting unit and attached to a ceiling of the vehicle, said light receiving element has a maximum sensitivity in a range from a horizontal to a downward direction with respect to incident light, said light receiving/emitting unit being divided along a circumference by center-passing radial lines created depending on the number of the unit sections, and the unit sections are combined in a generally disc shape to integrally constitute the light receiving/emitting unit.

4. The keyless entry system according to claim 1, further comprising a plurality of unit sections, and a partition wall formed of a substantially opaque material disposed between adjacent unit sections to prevent leakage of light between adjacent unit sections.

5. The keyless entry system according to claim 2, wherein one unit section of said light receiving/emitting unit is formed of a light transmitting material in a shape such that when combined as the light receiving/emitting unit and attached to a ceiling of the vehicle, said light receiving element has a maximum sensitivity in a range from a horizontal to a downward direction with respect to incident light, said light receiving/emitting unit being divided along a circumference by center-passing radial lines created depending on the number of the unit sections, and the unit sections are combined in a generally disc shape to integrally constitute the light receiving/emitting unit.

6. The keyless entry system according to claim 2, wherein a partition wall is formed of a substantially opaque material and disposed between adjacent unit sections to prevent leakage of light between adjacent unit sections.

7. The keyless entry system according to claim 3, further comprising a plurality of unit sections, and a partition wall formed of a substantially opaque material disposed between adjacent unit sections to prevent leakage of light between adjacent unit sections.

8. A keyless vehicle entry system for locking and unlocking at least one lock of a vehicle, comprising:
a projector configured to project light; and
a light receiving/emitting unit which includes a light receiving element configured to receive light from the projector and to communicate a signal corresponding to information associated with the light received from the projector, a light emitting element configured to emit light, and a processing unit configured to receive the signal from the light receiving element and in response to the signal to initiate at least one of locking the certain lock, unlocking the certain lock, causing the light emitting element to emit light, and causing the light emitting element to not emit light.

9. The keyless entry system according to claim 8, wherein said light receiving/emitting unit is divided into a plurality of unit sections each having a combination of light receiving element and light emitting element configured to indicate a position of a respective lock, the plurality of unit sections being combined and united.

10. The keyless entry system according to claim 9, wherein one unit section of said light receiving/emitting unit is formed of a light transmitting material in a shape such that when combined as the light receiving/emitting unit and attached to a ceiling of the vehicle, said light receiving element has a maximum sensitivity in a range from a horizontal to a downward direction with respect to incident light, said light receiving/emitting unit being divided along a circumference by center-passing radial lines created depending on the number of the unit sections, and the unit sections are combined in a generally disc shape to integrally constitute the light receiving/emitting unit.

11. The keyless entry system according to claim 9, wherein a partition wall formed of a substantially opaque material is disposed between adjacent unit sections to prevent leakage of light between the adjacent unit sections.

12. The keyless entry system according to claim 8, wherein the light is an infrared light.

13. The keyless entry system according to claim 8, wherein the light emitting/receiving unit includes a light transmissive resin encapsulating the light receiving element and light emitting element.

14. The keyless entry system according to claim 8, wherein the light emitting/receiving unit includes a light transmissive resin encapsulating a plurality of light receiving elements and light emitting elements.

15. The keyless entry system according to claim 14, wherein the light transmissive resin is shaped such that it directs light received from the projector toward a respective one of the light receiving elements.

16. The keyless entry system for use with a plurality of locks according to claim 14, wherein the light transmissive resin forms a housing and each of the light receiving elements is configured such that when the housing is attached to a vehicle ceiling, a first of the light receiving elements is closer to a respective one of the plurality of locks than a second of the light receiving elements, and the second of the light receiving elements is closer to a second of the plurality of locks than the first of the light receiving elements.

17. The keyless entry system for use with a plurality of locks according to claim 16, wherein the light emitting element is configured to emit a non-white colored light.

18. A keyless vehicle entry system for locking and unlocking at least one of a first lock and a second lock of a vehicle, comprising:
a projector configured to project light; and
a light receiving unit which includes a first light receiving element configured to receive light from the projector and to communicate a first signal corresponding to first information associated with the light received from the projector and a second light receiving element configured to receive light from the projector and to communicate a second signal corresponding to second information associated with the light received from the projector, and a processing unit configured to receive the first signal from the first light receiving element and in response to the first signal to initiate at least one of locking the first lock and unlocking the first lock and configured to receive the second signal from the second light receiving element and in response to the second signal to initiate at least one of locking the second lock and unlocking the second lock.

19. The keyless vehicle entry system of claim 18, further comprising:
a first light emitting element configured to emit light when actuated by the processing unit in accordance with the first signal from the first light receiving element; and
a second light emitting element configured to emit light when actuated by the processing unit in accordance with the second signal from the second light receiving element.

20. The keyless vehicle entry system of claim 18, wherein the light receiving unit includes a resin housing located over the first and second light receiving elements and shaped as a disc with a plurality of unit sections each directed to a respective lock of the vehicle.
